(19) United States
(12) Patent Application Publication
(10) Pub. No.: US 2011/0000758 A1
(43) Pub. Date: Jan. 6, 2011

(54) REDUCED DRAG CLUTCH PLATE

(75) Inventors: Markus Steinberger, Macedonia, OH (US); Craig Kneidel, Massillon, OH (US)

Correspondence Address: SIMPSON & SIMPSON, PLLC, 5555 MAIN STREET, WILLIAMSVILLE, NY, 14221-5406, US

(73) Assignee: LUK LAMELLEN UND KUPPLUNGSBAU BETEILIGUNGS KG, Buehl (DE)

(21) Appl. No.: 12/827,335

(22) Filed: Jun. 30, 2010

Related U.S. Application Data
(60) Provisional application No. 61/222,542, filed on Jul. 2, 2009.

(51) Int. Cl. F16D 13/00

(52) U.S. Cl. 192/30 R; 192/72

(57) ABSTRACT

A clutch plate including a first friction ring with an inner circumference and an outer circumference, and a resilient drag reducing element with a formed portion. The formed portion is at least partially radially disposed between the inner circumference and the outer circumference, extends axially beyond the first friction ring, and is compressible to be substantially circumferentially or radially aligned with the first friction ring. In some example embodiments of the invention, the resilient element is arranged to maintain a minimum clearance between the first friction ring and a mating surface.

### CROSS-REFERENCE TO RELATED APPLICATIONS

This application claims the benefit under 35 U.S.C. §119(e) of U.S. Provisional Application No. 61/222,542, filed Jul. 2, 2009, which application is incorporated herein by reference in its entirety.

### FIELD OF THE INVENTION

The invention relates generally to a clutch plate, and more specifically to a clutch plate with a resilient element aligned with a friction ring.

### BACKGROUND OF THE INVENTION

It is known to use wavy springs to bias clutch disks apart to reduce drag in an open condition. One example is shown in U.S. Pat. No. 3,613,848.

### BRIEF SUMMARY OF THE INVENTION

Example embodiments of the present invention broadly comprise a clutch plate including a first friction ring with an inner circumference and an outer circumference, and a resilient drag reducing element with a formed portion. The formed portion is at least partially radially disposed between the inner circumference and the outer circumference, extends axially beyond the first friction ring, and is compressible to be substantially circumferentially or radially aligned with the first friction ring. In some example embodiments of the invention, the resilient element is arranged to maintain a minimum clearance between the first friction ring and a mating surface.

In an example embodiment of the invention, the first friction ring includes a thickness and the resilient element comprises a flattened thickness, and the first friction ring thickness is the same or greater than the resilient element flattened thickness. In an example embodiment of the invention, the clutch plate includes at least one receiving hole, the resilient element includes at least one protrusion disposed in the at least one receiving hole, and the resilient element is attached to the clutch plate by deforming the protrusion.

In an example embodiment of the invention, the resilient element is formed from metal and is welded to the clutch plate. In an example embodiment of the invention, the resilient element includes a metal wire, the clutch plate includes at least two receiving holes, and the metal wire is woven through the receiving holes. The clutch plate includes a second friction ring disposed axially opposite to the first friction ring. The metal wire includes at least two arcuate segments extending axially beyond the first friction ring and at least one segment extending axially beyond the second friction ring.

In an example embodiment of the invention, the resilient element is formed from plastic, the clutch plate includes at least one receiving hole and the resilient element includes at least one protrusion. Attachment of the element to the clutch plate is accomplished by engaging the protrusion with the receiving hole.

Other example embodiments of the present invention broadly comprise a clutch plate including a layer of friction material and a resilient drag reducing element at least partially circumferentially aligned with the layer of friction material. The drag reducing element is biased such that a portion of the drag reducing element extends axially beyond the layer of friction material. The drag reducing element is compressible such that said portion is substantially circumferentially aligned with the layer of friction material.

Other example embodiments of the present invention broadly comprise a clutch plate including a layer of friction material having an inner circumference and an outer circumference and a resilient drag reducing element at least partially circumferentially aligned with the layer of friction material or at least partially radially disposed between the inner and outer circumferences. The drag reducing element is biased such that a portion of the drag reducing element extends axially beyond the layer of friction material. The drag reducing element is compressible such that said portion is substantially circumferentially or radially aligned with the layer of friction material.

Other example embodiments of the present invention broadly comprise a clutch plate assembly including a clutch plate with first and second radial surfaces, and at least one hole between the first and second radial surfaces. The assembly also includes a first friction ring having a first inner circumference and a first outer circumference, and a first resilient drag reducing element having a formed portion at least partially radially disposed between the first inner circumference and the first outer circumference. The first resilient element extends axially beyond the first friction ring.

The assembly also includes a second friction ring with a second inner circumference and a second outer circumference, and a second resilient drag reducing element with a formed portion at least partially radially disposed between the second inner circumference and the second outer circumference. The second resilient element extends axially beyond the second friction ring and the first and second resilient drag reducing elements are attached through the clutch plate hole.

### BRIEF DESCRIPTION OF THE DRAWINGS

The nature and mode of operation of the present invention will now be more fully described in the following detailed description of the invention taken with the accompanying drawing figures, in which:

FIG. 1A is a perspective view of a cylindrical coordinate system demonstrating spatial terminology used in the present application;

FIG. 1B is a perspective view of an object in the cylindrical coordinate system of FIG. 1A demonstrating spatial terminology used in the present application;

FIG. 2 is a partial perspective view of a clutch plate according to an example embodiment of the invention;

FIG. 3 is a section view of the clutch plate of FIG. 2 taken generally along line 3-3 in FIG. 2;

FIG. 4 is a section view of a resilient element of the clutch plate of FIG. 3;

FIG. 5 is a partial perspective view of a clutch plate with a resilient element having a single arc according to an example embodiment of the invention;

FIG. 6A is a section view of the clutch plate of FIG. 5 taken generally along line 6A-6A in FIG. 5;

FIG. 6B is a section view of the clutch plate of FIG. 5 with a resilient element having a double arc;

FIG. 6C is a section view of the clutch plate of FIG. 6B with an alternative attachment feature;

FIG. 6D is a section view of the clutch plate of FIG. 5 with a resilient element having four arcs;

FIG. 7A is a detail section view showing a press-fit connection between a clutch plate and two resilient elements;

FIG. 7B is a detail section view showing a snap-fit connection between a clutch plate having a tapered hole and a single resilient element;

FIG. 7C is a detail section view showing a snap-fit connection between a clutch plate and a single resilient element;

FIG. 7D is a detail section view showing a snap-fit connection between a clutch plate and two resilient elements;

FIG. 7E is a detail section view showing a locking connection between a clutch plate and two resilient elements;

FIG. 8 is a partial perspective view of a clutch plate with a woven resilient element according to an example embodiment of the invention;

FIG. 9 is a section view of the clutch plate of FIG. 8 taken generally along line 9-9 in FIG. 8;

FIG. 10 is a perspective view of a resilient element clip according to an example embodiment of the invention;

FIG. 11 is a perspective view of a resilient element ring according to an example embodiment of the invention;

FIG. 12 is a section view of a clutch plate with a radially-installed resilient element;

FIG. 13 is a section view of a clutch plate with a radially-installed resilient element having a locking divot;

FIG. 14 is a perspective view of the resilient element of FIG. 13.

### DETAILED DESCRIPTION OF THE INVENTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular embodiments only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

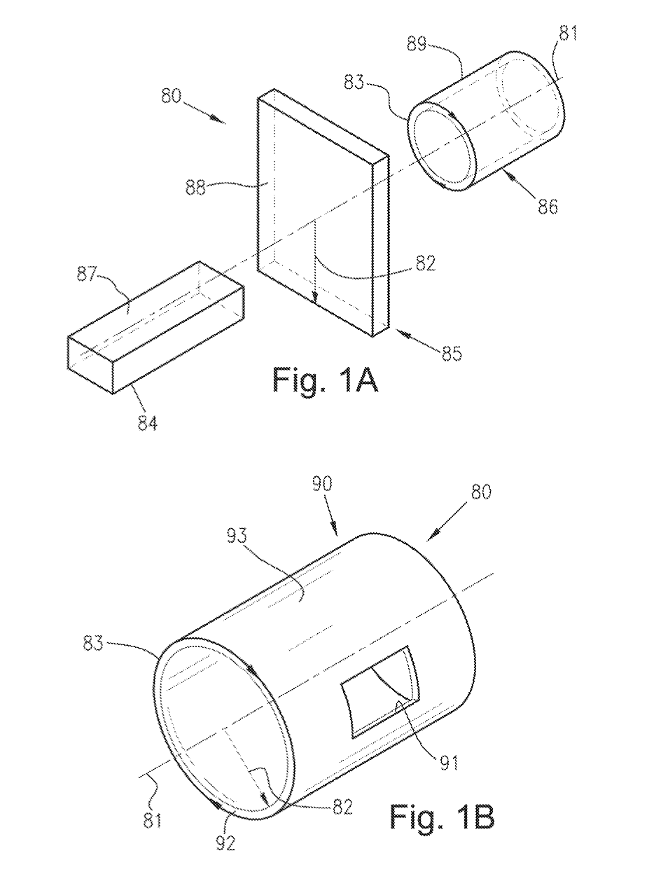

FIG. 1A is a perspective view of cylindrical coordinate system 80 demonstrating spatial terminology used in the present application. The present invention is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

FIG. 1B is a perspective view of object 90 in cylindrical coordinate system 80 of FIG. 1A demonstrating spatial terminology used in the present application. Cylindrical object 90 is representative of a cylindrical object in a cylindrical coordinate system and is not intended to limit the present invention in any manner. Object 90 includes axial surface 91, radial surface 92, and circumferential surface 93. Surface 91 is part of an axial plane, surface 92 is part of a radial plane, and surface 93 is part of a circumferential plane.

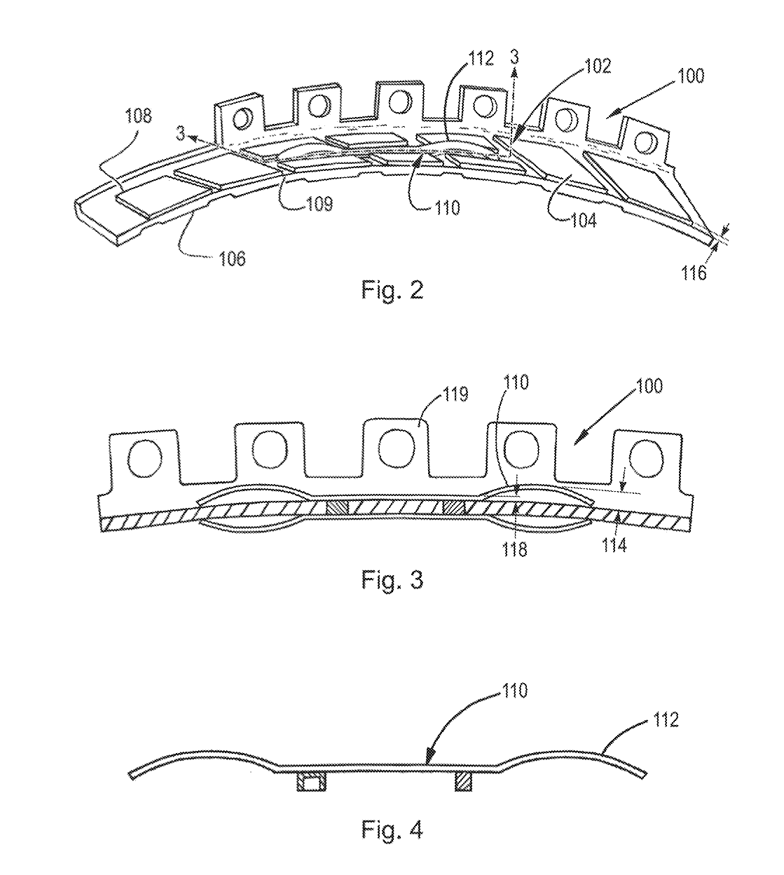

The following description is made with reference to FIGS. 2-4. FIG. 2 is a partial perspective view of a clutch plate according to an example embodiment of the invention. FIG. 3 is a section view of the clutch plate of FIG. 2 taken generally along line 3-3 in FIG. 2. FIG. 4 is a section view of a resilient element of the clutch plate of FIG. 3. Clutch plate 100 includes friction ring 102. Although friction ring 102 is shown as a set of individual segments 104, a continuous friction ring (not shown) is possible and should be considered within the scope of the invention. Ring 102 includes inner circumference 106 and outer circumference 108. Slot 109 is disposed between circumferences 106 and 108.

Clutch plate 100 also includes resilient drag reducing element 110. Element 110 includes formed portion 112. Portion 112 is disposed in slot 109, radially between inner circumference 106 and outer circumference 108. Although element 110 and portion 112 are shown fully disposed between circumferences 106 and 108, element 110 may be only partially disposed between circumferences 106 and 108, as will be discussed infra.

Formed portion 112 extends axially beyond friction ring 102. That is, height 114 of formed portion 112 from plate 100 is larger than thickness 116 of friction ring 102. However, formed portion 112 is compressible to be substantially circumferentially or radially aligned with friction ring 102. That is, axial force applied to portion 112 by an adjacent clutch plate, for example, compresses portion 112 so that it is no higher than thickness 116 of adjacent friction ring 102. Furthermore, thickness 116 of friction ring 102 is the same as or greater than flattened thickness 118 (i.e., material thickness) of formed portion 110.

Clutch plate 100 may be a component of a multiple-plate clutch disposed within an automotive torque converter (not shown). For example, tabs 119 may be engaged with a driving plate or a driven plate in the torque converter. Resilient element 110 may be arranged to maintain a minimum clearance between friction ring 102 and a mating surface (not shown) of an adjacent clutch plate, piston plate, or casing (not shown), for example.

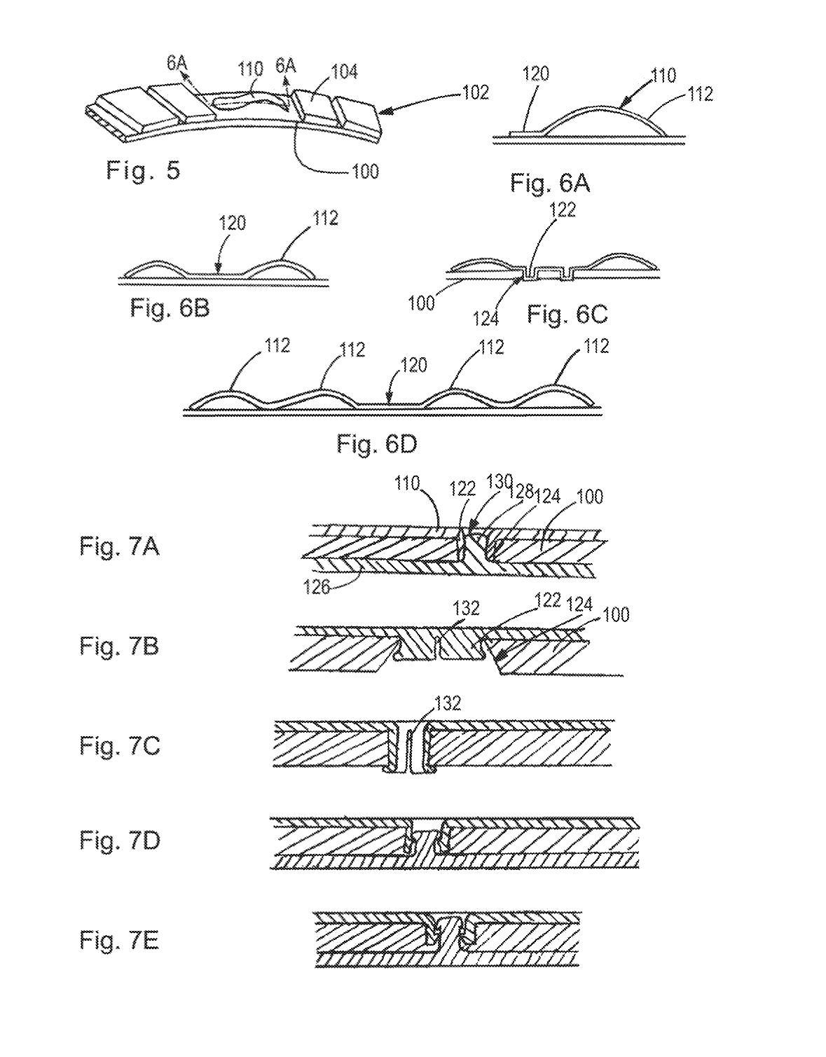

The following description is made with reference to FIGS. 5-6D. FIG. 5 is a partial perspective view of a clutch plate with a resilient element having a single arc according to an example embodiment of the invention. FIG. 6A is a section view of the clutch plate of FIG. 5 taken generally along line 6A-6A in FIG. 5. FIG. 6B is a section view of the clutch plate of FIG. 5 with a resilient element having a double arc. FIG. 6C is a section view of the clutch plate of FIG. 6B with an alternative attachment feature. FIG. 6D is a section view of the clutch plate of FIG. 5 with a resilient element having four arcs.

Resilient element 110 may be formed of metal and welded to plate 100 at attachment area 120, for example. As shown in FIG. 6C, resilient element 110 may be a metal strip with protrusions 122 disposed within receiving holes 124 in plate 100. Protrusions 122 may be deformed during or after assembly in plate 100. For example, protrusions 122 may be inserted into holes 124 in plate 100 and later deformed to fix element 110 and plate 100 together. Alternatively, protrusions 122 may be deformed during insertion into holes 124, snapping the two components together. Although FIGS. 6A-6D show certain configurations and numbers of formed portions 112, protrusions 122 and receiving holes 124, other configurations and numbers of formed portions, protrusions, and receiving holes are possible and should be considered within the scope of the invention. For example, additional formed portions may be added to better distribute separation force throughout the circumference of mating clutch plates.

The following description is made with reference to FIGS. 7A through 7E. FIG. 7A is a detail section view showing a press-fit connection between a clutch plate and two resilient elements. FIG. 7B is a detail section view showing a snap-fit connection between a clutch plate having a tapered hole and a single resilient element. FIG. 7C is a detail section view showing a snap-fit connection between a clutch plate and a single resilient element. FIG. 7D is a detail section view showing a snap-fit connection between a clutch plate and two resilient elements. FIG. 7E is a detail section view showing a locking connection between a clutch plate and two resilient elements.

Resilient element 110 may be formed of plastic. Clutch plate 100 may include receiving hole 124 for receiving protrusion 122 of element 110. As shown in FIG. 7A, clutch plate 100 may include resilient element 126 with protrusion 128. Protrusion 122 is inserted into hole 124 and protrusion 128 is inserted into center bore 130 of protrusion 122. Mating protrusions 122 and 128 fix elements 110 and 126 to plate 100. Similar snap-fit and locking connections are shown in FIGS. 7D and 7E, respectively. Protrusion 122 may contain slit 132 for easier assembly into hole 124. Hole 124 may be tapered as shown in FIG. 7B to ease assembly.

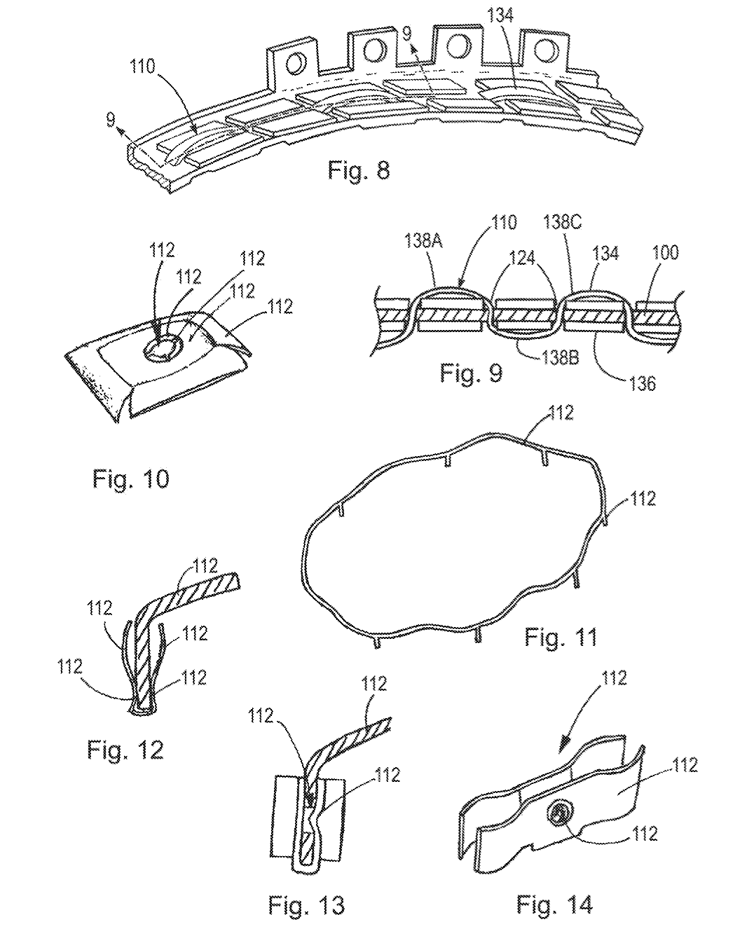

The following description is made with reference to FIGS. 8-9. FIG. 8 is a partial perspective view of a clutch plate with a woven resilient element according to an example embodiment of the invention. FIG. 9 is a section view of the clutch plate of FIG. 8 taken generally along line 9-9 in FIG. 8. Resilient element 110 may include metal wire 134. Clutch plate 100 includes receiving holes 124. Wire 134 is woven through receiving holes 124. That is, wire 134 passes through each of holes 124, forming an arcuate segment between the holes. As shown in FIG. 9, clutch plate 100 includes friction ring 136 disposed axially opposite friction ring 102. That is, rings 136 and 102 are on radial surfaces for the plate. As discussed supra, ring 136 may be a set of individual segments or a continuous ring (not shown). Wire 134 includes arcuate segments 138A, 138B, and 138C. Segments 138A and 138C extend axially beyond friction ring 102, while segment 138B extends axially beyond friction ring 136. It should be understood that clutch plate 100 is not limited to particular number of holes 124 or segments 138.

The following description is made with reference to FIG. 10. FIG. 10 is a perspective view of a resilient element clip according to an example embodiment of the invention. Clip 210 includes hole 220 and formed portions 212. Hole 220 includes slits 232 to ease assembly over a protrusion (not shown) on clutch plate 100. That is, clip 210 is assembled to plate 100 by deflecting tabs 240 of hole 220. In an example embodiment of the invention (not shown), clip 210 extends from inner circumference 106 to outer circumference 108 of friction ring 102.

The following description is made with reference to FIG. 11. FIG. 11 is a perspective view of a resilient element ring according to an example embodiment of the invention. Ring 234 includes protrusions 242 for assembly with plate 100. Protrusions 242 may be retained in holes 124 or projection welded to plate 100, for example. It should be understood that ring 234 is not limited to a particular number of protrusions 242.

The following description is made with reference to FIGS. 12-14. FIG. 12 is a section view of a clutch plate with a radially-installed resilient element. FIG. 13 is a section view of a clutch plate with a radially-installed resilient element having a locking divot. FIG. 14 is a perspective view of the resilient element of FIG. 13. Resilient element 310 includes formed portions 312. Element 310 is radially inserted onto clutch plate 100 such that formed portions 312 are radially disposed between inner and outer circumferences of friction rings (not shown) on axially opposite sides of ring 100 and clip portion 344 grips clutch plate 100. Element 310 may further include divot 346 installed into hole 124 to position element 310 on clutch plate 100. Elements 310 are preferably installed onto plate 100 radially outwardly to minimize the possibility of elements 310 becoming dislodged due to centrifugal forces experienced by the components when the clutch assembly is under rotation.

The formed portions of the inventive elements are at least partially disposed between inner and outer circumferences of the friction ring, preserving valuable radial space. As a result, the active radius of the clutch can be maintained at a radially outward position for maximum clutch capacity. Furthermore, the inner radial space occupied by the elements is minimal at most, so other assemblies (i.e., dampers, clutches) are not radially compacted by the drag reducing elements.

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

What we claim is:

1. A clutch plate comprising:
a first friction ring comprising an inner circumference and an outer circumference; and,
a resilient drag reducing element comprising a formed portion, wherein the formed portion is at least partially radially disposed between the inner circumference and the outer circumference, the formed portion extends axially beyond the first friction ring, and the formed portion is compressible to be substantially circumferentially or radially aligned with the first friction ring.

2. The clutch plate of claim 1, wherein the resilient element is arranged to maintain a minimum clearance between the first friction ring and a mating surface.

3. The clutch plate of claim 2, wherein the first friction ring comprises a thickness and the resilient element comprises a flattened thickness, and the first friction ring thickness is the same or greater than the resilient element flattened thickness.

4. The clutch plate of claim 2, wherein the clutch plate comprises at least one receiving hole, the resilient element comprises at least one protrusion disposed in the at least one receiving hole, and the resilient element is attached to the clutch plate by deforming the protrusion.

5. The clutch plate of claim 2, wherein the resilient element is formed from metal.

6. The clutch plate of claim 5, wherein the resilient element is welded to the clutch plate.

7. The clutch plate of claim 5, wherein the resilient element includes a metal wire.

8. The clutch plate of claim 7, wherein the clutch plate comprises at least two receiving holes, and the metal wire is woven through the receiving holes.

9. The clutch plate of claim 8 further comprising a second friction ring disposed axially opposite to the first friction ring, wherein the metal wire comprises at least three arcuate segments, at least two of which extend axially beyond the first friction ring and at least one segment extends axially beyond the second friction ring.

10. The clutch plate of claim 5, wherein the resilient element is a metal strip.

11. The clutch plate of claim 10, wherein the clutch plate comprises at least one receiving hole and the resilient element comprises at least one protrusion, and attachment of the element to the clutch plate is accomplished by engaging the protrusion with the receiving hole.

12. The clutch plate of claim 2, wherein the resilient element is formed from plastic.

13. The clutch plate of claim 12, wherein the clutch plate comprises at least one receiving hole and the resilient element comprises at least one protrusion, and attachment of the element to the clutch plate is accomplished by engaging the protrusion with the receiving hole.

14. A clutch plate, comprising:
a layer of friction material; and,
a resilient drag reducing element at least partially circumferentially aligned with the layer of friction material, wherein the drag reducing element is biased such that a portion of the drag reducing element extends axially beyond the layer of friction material and wherein the drag reducing element is compressible such that said portion is substantially circumferentially aligned with the layer of friction material.

15. A clutch plate, comprising:
a layer of friction material having an inner circumference and an outer circumference; and,
a resilient drag reducing element at least partially circumferentially aligned with the layer of friction material or at least partially radially disposed between the inner and outer circumferences, wherein the drag reducing element is biased such that a portion of the drag reducing element extends axially beyond the layer of friction material and wherein the drag reducing element is compressible such that said portion is substantially circumferentially or radially aligned with the layer of friction material.

16. A clutch plate assembly comprising:
a clutch plate comprising first and second radial surfaces, and at least one hole between the first and second radial surfaces;
a first friction ring comprising a first inner circumference and a first outer circumference;
a first resilient drag reducing element comprising a formed portion at least partially radially disposed between the first inner circumference and the first outer circumference, and extending axially beyond the first friction ring;
a second friction ring comprising a second inner circumference and a second outer circumference; and
a second resilient drag reducing element comprising a formed portion at least partially radially disposed between the second inner circumference and the second outer circumference, and extending axially beyond the second friction ring, wherein the first and second resilient drag reducing elements are attached to each other through the clutch plate hole.
